(19) United States
(12) Patent Application Publication
(10) Pub. No.: US 2010/0274842 A1
(43) Pub. Date: Oct. 28, 2010

(54) BUDDY LIST GENERATION METHOD

(75) Inventor: Hiroshi KODAKA, Chigasaki (JP)

Correspondence Address: FOLEY AND LARDNER LLP;SUITE 500, 3000 K STREET NW, WASHINGTON, DC, 20007, US

(73) Assignee: Hitachi, Ltd.

(21) Appl. No.: 12/632,273

(22) Filed: Dec. 7, 2009

(30) Foreign Application Priority Data
Apr. 27, 2009 (JP) 2009-107285

(51) Int. Cl. G06F 15/16

(52) U.S. Cl. 709/203; 709/204

(57) ABSTRACT

A registration content of a buddy list must be updated by a user in a presence system according to the prior art whenever a change of the organization of the user or that of a buddy occurs. A remote companion or buddy to be got in contact with changes, when the position of duty changes such as business trip or telecommuting. A presence server according to the invention includes an action record unit for recording actual use record such as a communication function and a buddy list generation unit capable of automatically generating a suitable buddy list on the basis of use record data for managing an action use record and use record data.

The present application claims priority from Japanese application JP2009-107285 filed on Apr. 27, 2009, the content of which is hereby incorporated by reference into this application.

### BACKGROUND OF THE INVENTION

This invention relates to an automatic generation method of a buddy list that will be suitable for a system providing a buddy list (or a contact list) and an action to the buddy list such as a presence system, and a system server.

A presence system that can know the present state (presence) of a communication remote companion and can execute various kinds of interlocking actions in response to the state change of remote equipment has been utilized as a core tool of in-house communication.

A system that allows a user to freely register a communication companion (for example, a buddy, a coworker or an associate) and can freely change the display sequence of the buddy has been proposed as the presence system.

A method that monitors those which change dynamically from a population list having buddies and selects those buddies having a state matching a buddy list generation rule and a method that automatically displays a buddy list corresponding to the state of a user from an action room for changing a display method of information representing the state of the buddy and from application information to which the action room is applied have been proposed.

JP-A-2004-246397, JP-A-2003-196243 and JP-A-2007-128541 are the patent references disclosing the methods described above.

### SUMMARY OF THE INVENTION

In the presence system according to the prior art, however, the user must update the registration content of the buddy list whenever an organization change of the user or that of a buddy occurs and whenever the place of work changes, and the user must bear a great burden.

The buddy with whom contact is to be made changes when the place of work changes such as a business trip or telecommuting. However, it is troublesome in practice to change the buddy list whenever the place of work changes.

Because the prior art technology does not take automatic updating of the buddy list with the actual use into consideration, the user must bear a large burden.

To solve these problems, the invention aims at providing a maintenance-free buddy list generation method, a system and a server. For example, the invention provides a buddy list generation method capable of automatically generating a buddy list in accordance with the use record of a plurality of communication functions such as telephone and e-mail.

The invention provides a buddy list generation method capable of switching a buddy list to a suitable list in accordance with the position of the user using the buddy list.

To solve the problems described above, the invention records the use record of the communication function to a use record data management unit when generating a buddy list and generates a suitable buddy list on the basis of this use record data.

The invention includes an action record unit for recording the use record of the communication function, a use record data management unit for managing the use record and a buddy list generation unit for generating a suitable buddy list on the basis of the use record data.

According to the invention, a buddy list can be automatically generated and it is not necessary for the user to register the buddy list and to change the display sequence. Therefore, the invention can provide a maintenance-free buddy list.

Other objects, features and advantages of the invention will become apparent from the following description of the embodiments of the invention taken in conjunction with the accompanying drawings.

### BRIEF DESCRIPTION OF THE DRAWINGS

FIG. 1 is a block view showing a system construction of a presence system according to an embodiment of the invention;

FIG. 2 is a table showing a construction of presence data;

FIG. 3 is a table showing use record data;

FIGS. 4A and 4B are tables each showing an example of a buddy list display data;

FIG. 5 is a table showing use record total data;

FIG. 6A and 6B are tables each showing a display example of a buddy list;

FIG. 7 is a flowchart of processing by an action recording unit;

FIG. 8 is a flowchart of processing by a total update unit;

FIG. 9A, 9B and 9C are tables each showing an example where a buddy list is automatically changed with a change of one's post;

FIG. 10A, 10B and 10C are tables each showing an example where a buddy list is automatically changed with a change of a position;

FIG. 11 is an explanatory view showing a construction of an ordinary presence system; and

FIG. 12 is a block diagram showing a hardware construction of an information processing unit.

### DESCRIPTION OF THE EMBODIMENT

A referred embodiment of the invention will be hereinafter explained with reference to the accompanying drawings.

### Embodiment 1

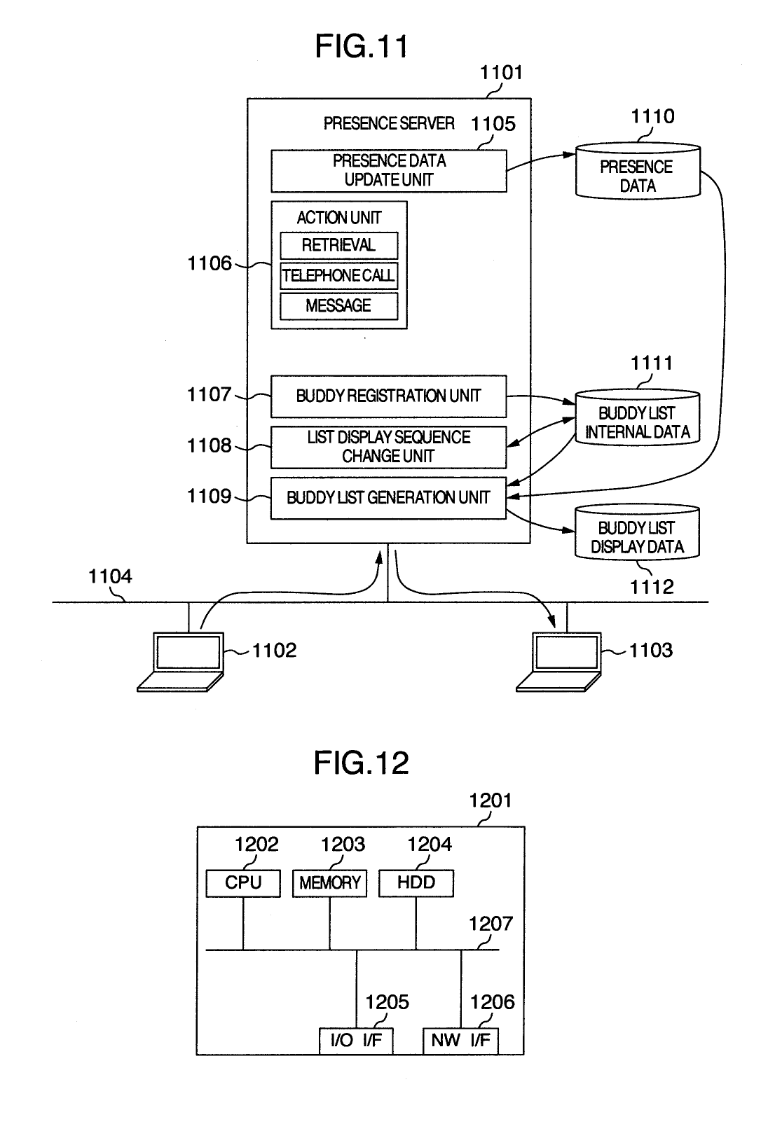

An ordinary presence system will be explained initially by way of example. The presence system includes a presence server 1101, terminals 1102 and 1103 of an information processing unit such as a personal computer and a network 1104 as shown in FIG. 11.

The presence server 1101 and the information terminals 1102 and 1103 communicate with one another in the presence system. The presence server 1101 receives, and holds, the change of the state (use state) of the terminal 1102. The presence server 1101 reports the state change to the other terminal 1103, whenever necessary, and can know the existence/absence of a specific terminal from an arbitrary terminal. The functional unit that materializes such an action in the presence server 1101 is a presence data update unit 1105 and the functional unit that manages the state of the terminals 1102 and 1103 is a presence data management unit 1110. The detailed explanation of these functional units will be omitted because it is well known in the art.

The terminals 1102 and 1103 are personal computers (PCs) or mobile telephones, for example. The state report method from these terminals 1102 and 1103 includes a system that manually inputs the state such as “in conference” or “be out” and an automatic report system that operates in the interlocking arrangement with log-in of PC and with a screen saver. Generally, display or action is executed as “terminal state=user's state” in many presence systems because a user using the terminal exists for the terminal 1102 or 1103.

The presence system includes those functions which are provided with the communication function such retrieval of a remote buddy, call to the remote buddy, sending of an e-mail and sending of a message. These functions are executed by an action unit 1106 in the presence server 1101. In FIG. 11, the action unit 1106 is shown built in the presence server 1101 but is sometimes packed on the side of the terminals 1102 and 1103, or its function is executed by other server.

The use method of the communication function in the presence system first confirms the present state of the remote companion of communication (seated/not seated/left seat) and then executes the action such as message transmission or call of telephone in accordance with the state of the remote companion. It is therefore desirable that the state of the remote companion is always displayed on the screen for those companions with which communication is to be established frequently. The list of such communication companions (for example, buddies, coworkers or associates) is referred to as a “buddy list” or a “communication list”.

In the presence system in which the user can freely register the buddies and can freely change the display sequence of the buddies, the presence server 1101 includes a buddy registration unit 1107 as a registration function of the buddies, a list display sequence change unit 1108 for changing the display sequence, a buddy list generation unit 1109 for generating display data of the buddy list and a management unit 1111 for managing the buddy list display data (internal data) that manages the buddy list registration content for each user.

FIG. 6A shows a screen display example of the buddy list 600 at the terminal (1102, 1103). The buddy list 600 includes a display part 601 for displaying the list of the buddies, a registration button 602 for registering the buddies and an UP button 603 and a DOWN button 604 for changing the display sequence of the list. A popup menu 605 is prepared to execute the communication function for the buddies as shown in FIG. 6B.

FIG. 6A illustrates the example where a user “Tetsuro” registers “Taro”, “Jiro” and “Saburo” as the buddies and displays the buddy list. The operation of displaying “Jiro” to the uppermost position of the buddy list from this screen is made by selecting “Jiro” by a mouse and pushing the UP button 603.

The operation of sending a message to “Saburo” from this screen is made by selecting “Saburo” by the mouse, displaying the popup menu 605 by right clicking the mouse as shown in FIG. 6B and selecting the “message” function.

However, many of the buddy lists used in the past allow the user to freely register the buddy and to change the display sequence but none of them can automatically register the buddy and change the display sequence as described above.

JP-A-2004-246397 describes a so-called “dynamic generation method” of the buddy list by monitoring those buddies which change dynamically from a population list and selects those having the state which matches the buddy list generation rule. JP-A-2003-196243 and JP-A-2007-128541 propose methods for automatically displaying the buddy list corresponding to the user condition from an “action rule” set for changing the method of the state information display of the buddies and an “application condition” representing the state under which the action rule is applied. However, these methods are not yet free from the problems described above.

The invention is completed to solve these problems and a preferred embodiment thereof will be hereinafter explained with reference to the accompanying drawings. Though the explanation will be given on a dynamic generation method of the buddy list in the presence system, the scope of the invention is in no way limited to the presence system.

FIG. 1 is a structural view of the presence system according to an embodiment of the invention. The presence system includes a presence server 101, terminals 102 and 103 and a network 104.

The presence server 101 includes processing units such as a presence data update unit 105 for updating presence data (information) of a presence data management unit 109 that manages a presence state, an action unit 106 for executing functions such as message and telephone, an action record unit 107 for leaving the action record executed by the action unit 106 in a use record data management unit 110 and a buddy list generation unit 108 for generating a buddy list on the basis of the actual result of the executed functions; a use record data management unit 110 for managing the record of the executed functions; a buddy list display data (internal data) management unit 111 for managing a screen display image of the buddy list; and a position data server 112 that manages seating positions of users (external data). Here, each management unit may use a memory, a file or a database.

The presence server 101 is constituted by an ordinary information processing unit. FIG. 12 shows an example of its block construction. Referring to FIG. 12, the information processing unit 1201 constituting the presence server 101 has a CPU 1202 having a processing function, a memory 1203 for storing each data, a hard disk drive 1204, an I/O interface 1205 and a network interface 1206 that are connected to one another through a communication bus 1207.

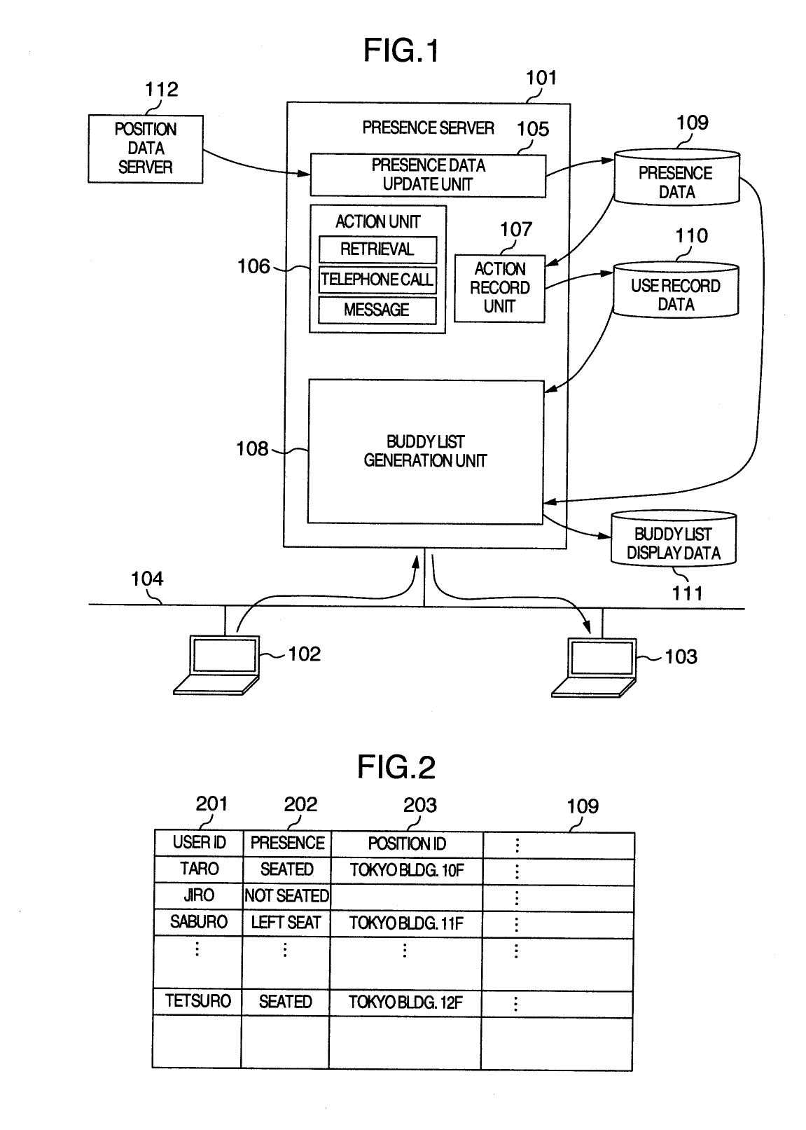

FIG. 2 shows a structural example of the presence data of the presence data management unit 109 shown in FIG. 1. The presence data is composed of information representing the presence of the present user and its position. More concretely, the presence data has a table construction including a user ID 201 representing the user, the presence 202 representing seated/not seated/leaving seat of the user, a position ID 203 representing the position such as a floor of a building or a seating position and other status information. These kinds of information are associated with one another as shown in the drawing.

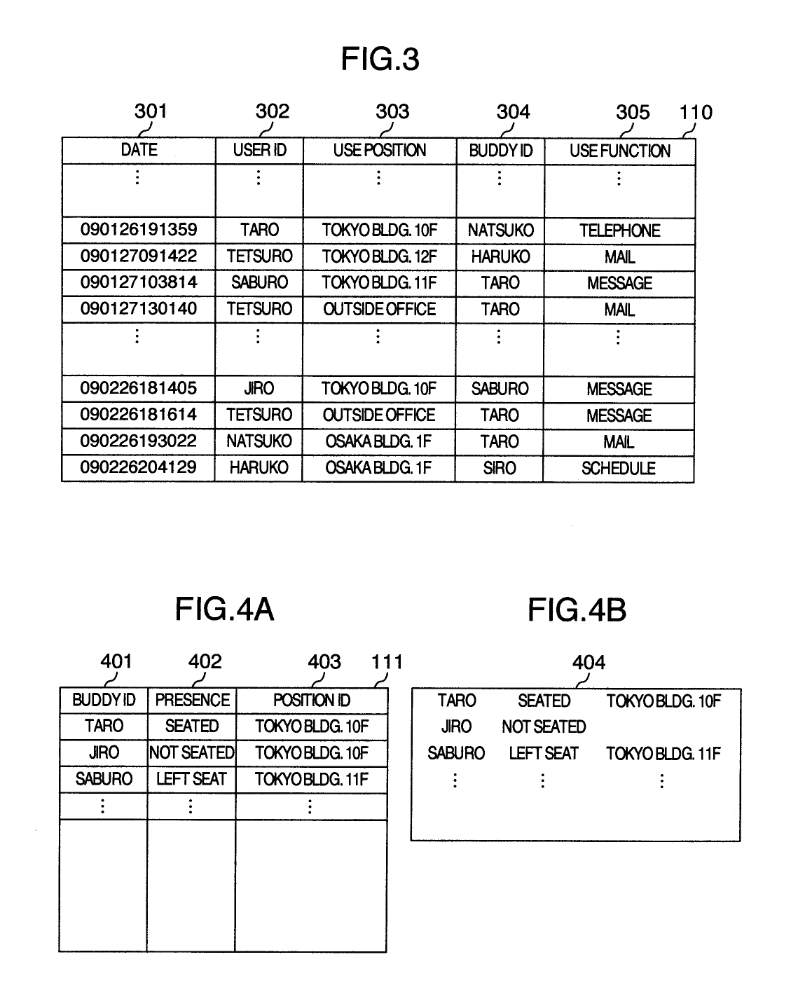

FIG. 3 tabulates a data construction of the data of the data storage unit 110 that stores the user record data in FIG. 1. A user record data management unit 300 stores the record of an arbitrary user using an arbitrary action in time series. The use record data has concretely a table construction including date information 301 representing the date of execution of an arbitrary action, a user ID 302 representing the user who uses the arbitrary action, information 303 representing the use position of the user who executes the arbitrary action, a buddy ID 304 as the information representing the buddy user executing the arbitrary action and user action information 305 as the kind of the arbitrary action executed. These kinds of information are associated with one another as shown in the drawing.

FIG. 4A shows a construction of data of the buddy list display data management unit 111 shown in FIG. 1. The buddy list display data is a buddy list screen display image and has a table construction including a buddy ID 401 as the information representing the name of the buddy, presence 402 that represents presence data of the buddy and a position ID 403 as information that represents the position of the buddy. When the data shown in FIG. 4A is registered, for example, the buddy list 404 has the screen display shown in FIG. 4B.

The position data server 112 of the presence server 101 holds the seating position of the user. A resolution method for specifying the seating position of the user includes various means such as a method that uses a network apparatus, a method that uses an infrared apparatus and a method that uses wireless equipment. The position data server 112 specifies the seating position of the user by using these position resolution means and updates and holds the position data. The presence server 101 can return the seating position of the user in response to the inquiry from other servers using the user ID as the key.

It will be assumed in this embodiment that an update report is given from the position data server 112 to the presence server 101 to update the seating position of the presence data 109 whenever the seating position of the user changes.

The presence data update unit 105 has main processing functions of the presence server 101 that receives the state report from the terminal (102) of a certain user, registers the state to the presence data management unit 109 and reports the state to the terminal (103) of other user whenever necessary.

Receiving the state report “seated” from the terminal of the user “Taro”, for example, the position data server 112 acquires “Tokyo Building 10th Floor” as the position data of “Taro” from the position data server 112, updates the presence of “Taro” to “seated” and the position ID of “Taro” to “Tokyo Building 10th Floor” and can thus acquire the registration information of “Taro” shown in FIG. 2.

The action unit 106 has the processing function for executing the function such as message and telephone for the buddy in the same way as the prior art functions. A part of the functions of the action unit 106 may be packaged to the terminals (102, 103) side.

The action record unit 107 is one of the characterizing processing of the invention. The use condition of each function executed by the action unit 106 is recorded as the use record data to the use record data management unit 110.

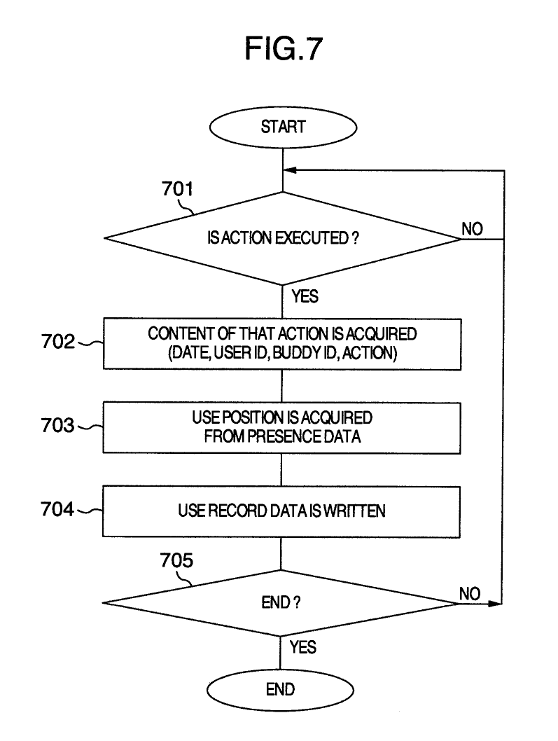

FIG. 7 shows a processing flow of the action record unit 107. The processing operation of this unit will be explained next.

The action record unit 107 starts operating simultaneously with the activation of the presence server 101.

After the activation, the action unit 106 always monitors whether or not the execution of the action occurs (step 701).

When the execution of the action occurs, the date and time of the occurrence, the user ID of the user executing the action and the kind of the action are acquired from the action unit 106 (step 702).

Further, the use position of the user ID is acquired from the presence data 109 (step 703).

Then, these data acquired are then written as the use record data to the use record data management unit 110 (step 704).

Finally, the flow returns to the monitor loop of the action execution unless the presence server 101 finishes (step 705).

As a result of the processing described above, the user of the presence system can wholly record the action execution operated for the buddy to the use record data management unit 110.

When the function of the action unit 106 is packaged and allotted to the terminal (102, 103) side, the action unit 106 and the action record unit 107 communicate with each other and can register the content of the action execution on the terminal 102, 103 side to the use record data management unit 110 through the action record unit 107.

The buddy list generation unit 108 constitutes also one of the characterizing features of the invention. The buddy list generation unit 108 has the functions of generating the buddy list display data on the basis of the use record data (110) and accumulating it in the buddy list display data management unit 111.

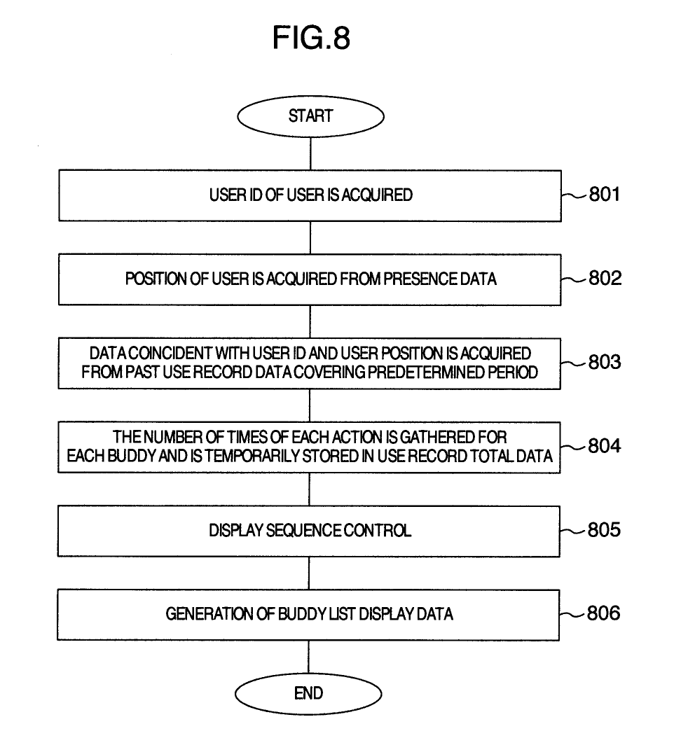

The operation when the content shown in FIG. 3 is stored as the use record data in the use record data management unit 110 will be explained with reference to the processing flow shown in FIG. 8.

The buddy list generation unit 108 starts operating upon receiving the buddy list display request from the user of the terminal.

First, the user ID of the user is acquired (step 801). The user is assumed to be “Tetsuro” this time.

Next, the present position of the user “Tetsuro” is acquired from the presence data of the presence data management unit 109 (step 802). For example, “Tokyo Building 12F” as the position ID of “Tetsuro” is acquired in the case of the data of the presence data management unit 109 shown in FIG. 2.

The data that is in conformity with the user ID and the use position is taken out from among the user record of a predetermined period from the data of the use record management unit 110 (step 803). For example, all the data having the user ID “Tetsuro” and the position ID “Tokyo Building 12F” are acquired from the use record of the past one month. When a predetermined period can be designated arbitrarily, the use data can be collected in accordance with this period.

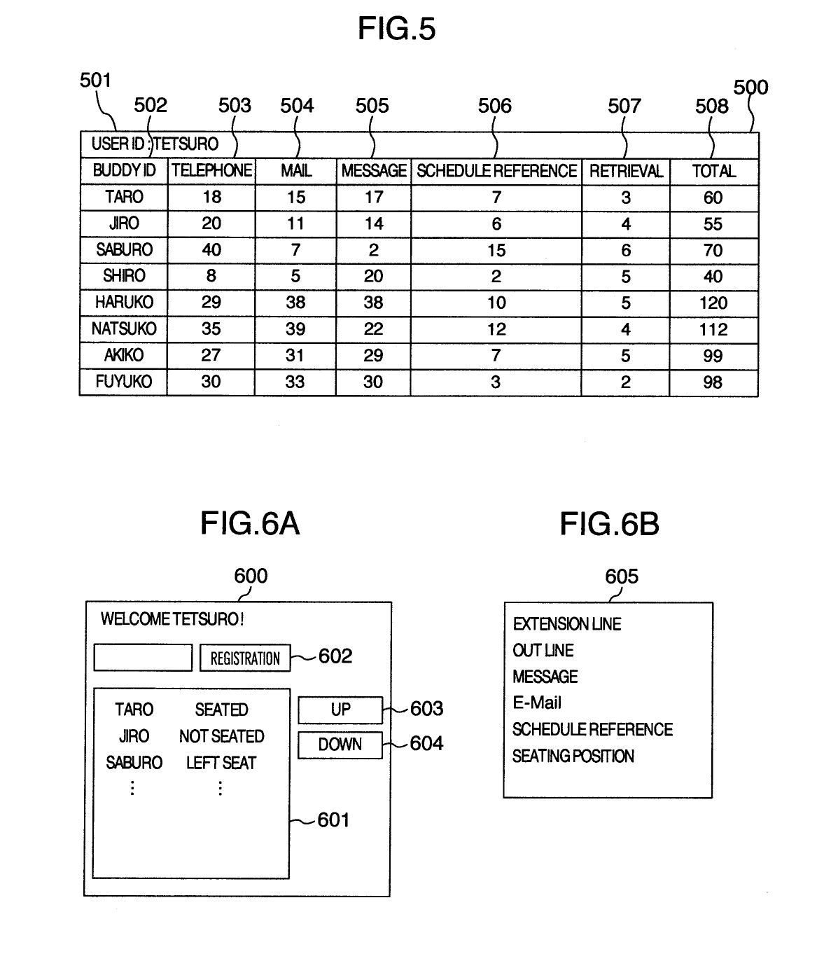

Next, the data representing which function has been used how many times so far are totalized for each buddy ID from the data acquired and are temporarily stored in the buddy list display data management unit 111 (step 804). The format of the total data temporarily stored is, for example, use record total data 500 that totalizes the number of times of the use of each function such as telephone and e-mail from the user ID for the buddy ID as shown in FIG. 5. Assuming hereby that “Tetsuro” makes telephone calls 18 times to “Taro”, and sends e-mails 17 times, schedule reference 7 times and retrieval 3 times, the use record total data 500 is tabulated in the column “Taro” shown in FIG. 5. The total number of times of use to other buddies is likewise totalized and the use record total data 500 shown in FIG. 5 can be acquired.

The use record total data 500 has the information representing the user ID 501, the buddy ID 502 and the use record (telephone 503, Mail 504, Message 505, schedule reference 506, retrieval 507) for each buddy ID and the total.

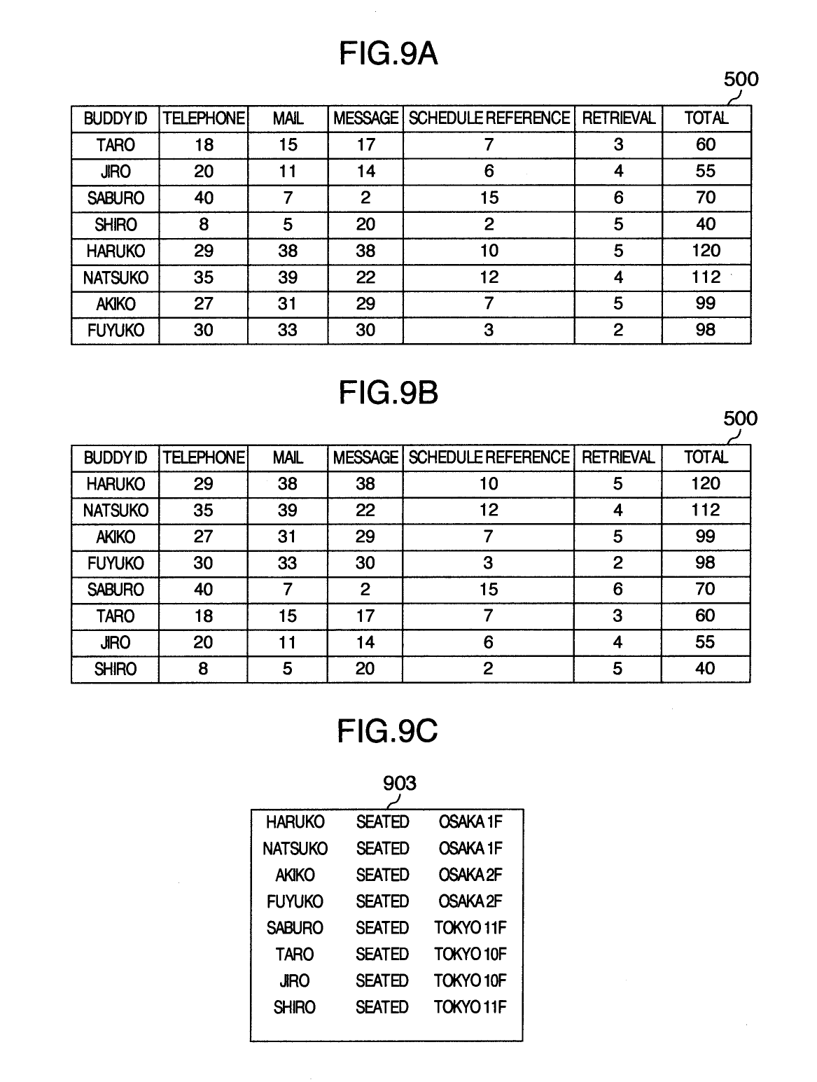

Next, the use record total data 500 is sorted by the display sequence control processing (step 805). When the use record total data 500 has the content shown in FIG. 9A, for example, the data is sorted in accordance with the number of times of the execution of actions and the result shown in FIG. 9B can be acquired.

Finally, the buddy list display data 111 is generated by looking up the information of the presence data 109 in the sequence of the use record total data 500 by the buddy list display data generation processing (step 806). When the use record total data 500 shown in FIG. 9B exists and is displayed on the screen as the actual buddy list, for example, display shown in FIG. 9C can be acquired.

The buddy list of a certain user can be generated automatically by a series of processing described above in accordance with the actual result of the use of the user using the functions.

Buddy registration, the change of the display sequence and so forth have been made manually in the buddy list according to the prior art but the system (embodiment) of the present invention can achieve maintenance-free operations without requiring at all the operations such as buddy registration and the change of the display sequence.

When the actions such as retrieval and message are continuously executed to new buddies after personnel changes of posts, for example, the buddy list of the new buddies can be changed. In the system (embodiment) of the invention, however, the buddy list of the new buddies generated automatically does not appear on the higher order of the list when the action is executed only once for the entirely new buddy, and ease-of-use may deteriorate. This problem can be solved by displaying on the screen the buddy lists of several buddies, for which the action execution is made just immediately, separately from the buddy list generated automatically. The information of the buddy list for which the action execution is made just immediately can be taken out readily from the latest information of the use record data 110.

Next, a realization method for automatically generating a buddy list corresponding to the operation position of the user will be explained.

FIG. 8 shows a processing flow of the buddy list generation unit 108. The explanation will be given on the case in the drawing where the user “Tetsuro” uses the presence system from “outside company”.

First, when the present position of the user ID “Tetsuro” is searched from the presence data management unit 109 in step 802, “outside company” is acquired.

In the subsequent step 803, all the data where the user ID is “Tetsuro” and the use position is “outside company” are acquired from among the use record of the past one month, for example.

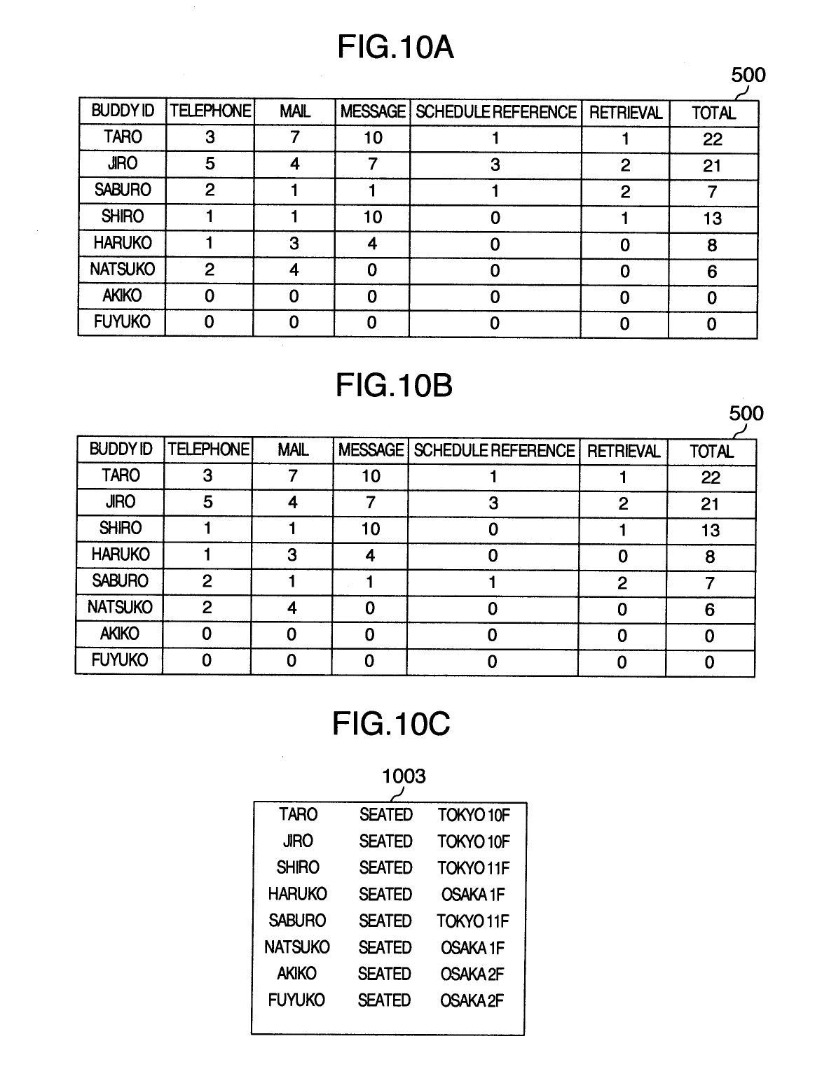

When the data are then totalized in step 804, the use record total data 500 becomes the one shown in FIG. 10A, for example.

When the use record total data 500 is sorted by the total number of times of the execution of action in the same way as described before in step 805, the data are aligned as shown in FIG. 10B.

When these data are displayed on the screen as the buddy list in step 806, the display result shown in FIG. 100 can be acquired.

As a result of a series of processing described above, the content of the buddy list can be automatically switched when the action position of the user changes.

Consequently, when the user operates inside the office, the buddy at a different position with whom frequent contact is generally established appears on the higher order but when the user operates outside the office such as when communication is frequently made to confirm the business, the personnel in charge in the office appears on the hider order of the buddy list. In this way, the buddy list can be automatically switched to the one that is suitable for that position.

In the processing flow shown in FIG. 8, the step 805 is the display sequence control processing for deciding the display sequence of the buddy list and is an important processing for deciding the display sequence.

The display sequence control step 805 uses the use record total data 500 as its input. Therefore, various sequence decision methods may be available by using the use record total data 500.

For example, rearrangement is made in the following way.

Rearrangement is simply made in accordance with a greater total number of times of the action or a smaller total number of times of action.

Alternatively, rearrangement is made in accordance with the number of times of the execution of action by taking only a certain action into consideration.

Rearrangement is made by the total number of times of the combination of the AND condition and the OR condition of execution of a plurality of actions.

Rearrangement is made in accordance with the total number of times by applying a weight function to each action.

Still alternatively, rearrangement is made in accordance with the existence/absence of the execution of a specific function.

These rearrangement methods can be provided as a display option and a focusing option of the buddy list.

The embodiment described above can control the display sequence of the buddies on the basis of the use record of a plurality of communication means. Therefore, the display sequence can be switched to the sequence of the specific actions such as message and telephone.

Since the buddy list is switched in accordance with the position at which the presence is used, members at different positions who have greater association from the business aspect appear on the higher order when the user is inside the office, for example, but when the user works outside the office, the members inside the office are displayed on the higher order. In this way, the buddy lists can be switched to those which are more suitable for the respective positions.

As still another use method, those who have had a contact in the past can be displayed in the list form in the proximity of the office as the destination of a business trip.

This invention can be used for the presence system having the buddy list. Alternatively, the invention can be applied not only to the presence system but has also the possibility of rendering the buddy list maintenance-free in a system that provides the buddy list and the actions for the buddy list.

It should be further understood by those skilled in the art that although the foregoing description has been made on embodiments of the invention, the invention is not limited thereto and various changes and modifications may be made without departing from the spirit of the invention and the scope of the appended claims.

Claims:

1. A method for generating a buddy list, in a server including an action unit having a processing function for executing a desired action (message, telephone and so forth) for buddies of a buddy list, an action record unit for recording the use state of each action executed by said action unit as use record data to a use record data management unit and a buddy list generation unit having a processing function of generating buddy list display data on the basis of the data of said use record data management unit and accumulating the data to a buddy list display data management unit, the method comprising the steps of:
recording by said action record unit the use state of the action executed by said action unit as use record data to said record data management unit; and
automatically generating the buddy list by said buddy list generation unit by looking up said use record data.

2. A method for generating a buddy list according to claim 1, wherein said use record data contains information representing the position of the user, and said buddy list is automatically generated in accordance with said information.

3. A server system including user terminals, a server for generating a buddy list on the basis of position data representing the position of a user of said terminals and a network connecting said terminals to said server, wherein said server includes:
a position data update unit for updating said position data of a position data storage unit on the basis of said position data of said terminal user;
an action unit for executing an action function of said terminal user;
an action record unit for recording the execution of the action by said action unit as use record data with the position data of said position data storage unit to a use record data management unit; and
a buddy list generation unit for generating buddy list display data on the basis of the data of said use record data management unit and the position data of said position data storage unit and storing said buddy list display data to a buddy list display data storage unit.

4. A server system according to claim 3, wherein said server is a presence server and said position data management unit manages presence data.

5. A server for generating a buddy list on the basis of position data presenting a position of a terminal user comprising:
a position data update unit for updating position data of a position data storage unit on the basis of the position data of said terminal user;
an action unit for executing an action function of said terminal user;
an action record unit for recording the execution of the action by said action unit as use record data with the position data of said position data storage unit to a use record data management unit; and
a buddy list generation unit for generating buddy list display data on the basis of the data of said use record data management unit and the position data of said position data storage unit and storing said buddy list display data to a buddy list display data storage unit; and
wherein said action record unit accumulates action use record by the action executed by the user to said use record data management unit and said buddy list generation unit automatically generates the buddy list by looking up said action use record.
